(19) United States
(12) Patent Application Publication
(10) Pub. No.: US 2005/0004791 A1
(43) Pub. Date: Jan. 6, 2005

(54) Perceptual noise substitution

(76) Inventors: Leon Maria Van De Kerkhof, Eindhoven (NL); Arnoldus Werner Johannes Oomen, Eindhoven (NL)

Correspondence Address: Philips Electronics North America Corporation;Corporate Patent Counsel, PO Box 3001, Briarcliff Manor, NY, 10510, US

(21) Appl. No.: 10/495,942

(22) PCT Filed: Nov. 4, 2002
(86) PCT No.: PCT/IB02/04601

(30) Foreign Application Priority Data
Nov. 23, 2001 (EP) 012004533.2

(51) Int. Cl. G10L 19/00

(52) U.S. Cl. 704/216

(57) ABSTRACT

A method using synthetic noise sources in a multi-channel audio coding system for encoding a set of audio signal wherein correlated noise components are present. The method comprises the step of determining, from the relation between said audio signals, a composition of noise sources, the composition being such that the noise sources in said composition are mutually uncorrelated, so that said composition of noise sources synthesizes said noise components in a relation-preserved way. The method may further comprise the step of encoding die noise sources, by determining for each noise source a set of noise parameters for synthesizing said source and a set of transformation parameters for generating said composition of noise sources.

The invention relates to a method using synthetic noise sources in a multi-channel audio coding system for encoding a set of audio signals wherein correlated noise components are present.

By encoding only perceptually relevant quantities of noise sources, such as, for instance, the total acoustic energy of noise in a specific frequency range, perceptually irrelevant audio information may be discarded so that a considerable signal compression may be gained. International application WO99/04505 describes such a method. In this method, noise-like components of an input signal are detected on a frequency-band basis. The noise-like components are parametrised, and only the total power of the substituted spectral coefficients is transmitted. In a decoder, the encoded audio channels are reconstructed by inserting random noise sources with the desired power for the substituted spectral coefficients.

Such a straightforward substitution causes an unnatural hearing sensation in the case where multiple audio channels actually exhibit a degree of inter-correlation. This unnatural perception is due to the fact that the human ear is able to identify a correlation between audio signals coming from different directions. The correlation between signals determines the “stereo image”, the spatial perception of sound sources. If the left and right signals in a two-channel loudspeaker setup are fully correlated, the human auditory system will perceive this as a single sound source positioned in between the speakers. If the signals are uncorrelated, two separate sound sources positioned at the left and right speakers will be perceived. Partly correlated signals will generally be perceived as a wide sound source in between the speakers. Negative correlation can even lead to perceived sound source positions outside the speakerbase. Therefore, if correlation of the sound in left and right speakers is lost, the intended stereo effect disappears and a listener perceives a less natural hearing sensation.

In other words, if a sound produced from multiple audio channels reflects a single audio source that was recorded via said channels, a reconstruction of said audio source with uncorrelated noise sources would appear to be unnatural.

In the aforementioned application, it is attempted to compensate for the above-described effect by encoding a bit value, which, in an active state, triggers a synthesizer to use the same noise source for both left and right channel. In a normally inactive state, left and right channels are synthesized from independent noise sources.

Although such a provision offers an improvement as compared to a synthesis of audio channels using inherently uncorrelated noise sources, synthesized sounds still lack naturalness because, in practice, information in the encoded audio channels, describing a degree of correlation between the channels is not used. Therefore, a reconstruction of the original sound is only partly possible when using the known method and the ear still perceives a less natural hearing sensation.

The invention aims to obviate the above-mentioned problem and to provide an improved audio coding, wherein a perceptually near original reconstruction of noisy components in multiple audio channels is possible, with a preserved degree of correlation between the channels.

Accordingly, the method of the invention comprises the step of:
determining, from the relation between said audio signals, a composition of noise sources, the composition being such that the noise sources in said composition are mutually uncorrelated, so that said composition of noise sources synthesizes said noise components in a relation-preserved way.

According to the inventive method, noise components present in an audio signal are composed from noise sources that synthesize perceptually relevant correlation-preserved noise components present in at least one frequency band of said audio signals. These synthesizing noise sources are mutually uncorrelated. Therefore, these noise sources can be easily reconstructed by independent noise generators.

Although the method can be applied to transmit noise sources that are not encoded, in a preferred embodiment, the inventive method further comprises the steps of encoding the noise sources, by determining for each noise source a set of noise parameters for synthesizing said source and a set of transformation parameters for generating said composition of noise sources.

Furthermore, a preferred embodiment of the invention comprises the step of transmitting said sets of noise parameters for synthesizing each noise source and transmitting said set of transformation parameters for forming said plurality of noise sources. More specifically, said noise parameters and said transformation parameters are determined by orthogonalizing the correlation matrix of said set of audio channels. This orthogonalisation may be, for a time-varying intercorrelation between audio channels, performed on a frame-by-frame basis. The size of a frame may depend on the time frame through which the inter-channel correlations can be considered to be constant.

The invention is preferably applicable in a case wherein the set of audio signals is divided into a selected set of frequency bands, at least one of the frequency bands comprising noise-like signals. Non-noisy components present in said audio signals may be encoded by sinusoidal coding.

The invention also relates to a coding method using synthetic noise sources in a multi-channel audio coding system for encoding a set of audio channels, the method comprising the steps of:
receiving sets of noise parameters for synthesizing noise sources and receiving a set of transformation parameters determined according to the inventive method;
generating, in response to said noise parameters, a set of synthesized noise sources; and
generating a set of audio signals by forming each audio signal as a plurality of noise sources according to said transformation parameters.

In this way, encoded and transmitted noisy audio signals may be decoded and a corresponding multi-channel correlation preserved audio signal may be synthesized.

Furthermore, the invention relates to an audio encoder, comprising:
means for detecting, in at least one frequency band of said audio signals, an auto-correlation and a cross-correlation between each one of a set of audio signals; and
processing means for determining, from the relation between said audio signals, a composition of noise sources, the composition being such that the noise sources are mutually uncorrelated, so that said composition of noise sources synthesizes said noise components in a relation-preserved way.

The encoder may further comprise means for encoding said noise sources as sets of noise parameters for synthesizing each of said sources, transmitting means for transmitting the sets of noise parameters and for transmitting said set of transformation parameters for forming said plurality of noise sources.

Likewise, the invention relates to an audio decoder comprising:
receiving means for receiving sets of noise parameters for synthesizing noise sources and for receiving a set of transformation parameters for forming a plurality of said noise sources,
a set of noise generators for generating noise sources, in response to the noise parameters; and
synthesizing means for synthesizing audio signals with perceptually relevant correlation-preserved noise components by forming, in response to the set of transformation parameters, for each audio signal a plurality of said set of noise sources.

The encoder and decoder may be physically distinct signal processing apparatus or may be present as one or several units in a single signal processing apparatus. The transmission may be a wireless transmission, or a transmission through the Internet, in fact, any kind of transmission. The transmission may also be done via a physical data carrier, such as a magnetic disk or a CD-rom etc.

The invention also relates to a data carrier, comprising a set of noise parameters for synthesizing noise sources and comprising a set of transformation parameters for forming a plurality of noise sources according to the above-described method.

Further objects and features of the invention will become apparent from the drawings, wherein:

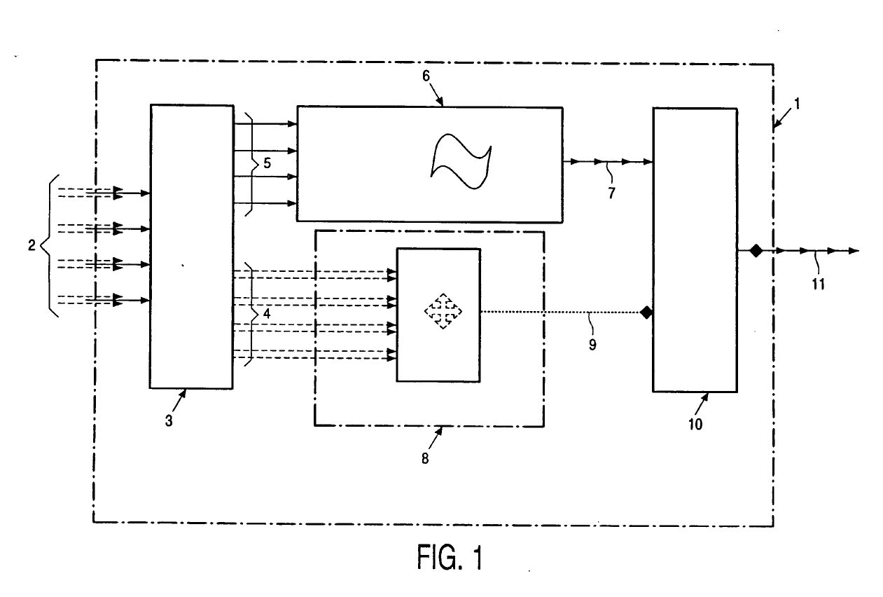

FIG. 1 is a schematic illustration of an encoding apparatus implementing the coding method according to the invention.

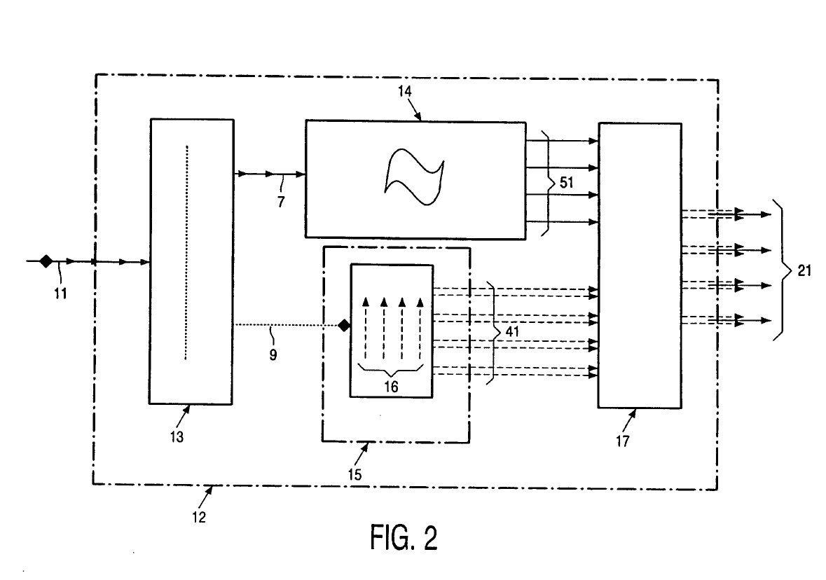

FIG. 2 is a schematic illustration of a decoding apparatus implementing the coding method according to the invention.

FIG. 1 shows an encoder 1 for encoding a four-channel audio signal. The audio channels are represented by four composite arrows 2, each arrow 2 representing one audio channel of four channels. For the invention, the actual number of channels is irrelevant, because obviously, the inventive method can be applied in any audio system as long as more than 1 channel is present. The audio channel 2 comprises an audio signal which in at least one frequency band comprises noise components. In actual embodiments, an audio signal with audible frequency components is usually split up into several (usually logarithmically scaled) frequency bands, although the method according to the invention can also be performed directly on full bandwith audio signals. For each, or a specific number, of these frequency bands (especially in relevant frequency bands where the human ear is sensitive to correlated signals), the inventive method can be applied.

The multi-channel signal 2 is filtered in a filter stage 3. The filter 3 splits up the audio signals into noisy parts 4 and in non-noisy parts 5. Non-noisy parts 5 of the signal 2 are directed towards a sinusoidal coding circuit 6. This circuit 6 generates compressed encoded data 7, which represents non-noisy audio information of said audio signals 2.

The noisy parts 4 are directed towards a circuit 8 encoding the noise in a correlation-preserved way according to the invention. In said circuit 8, the relation between said audio signals is determined and a composition of noise sources is identified, the composition being such that the noise sources in said composition are mutually uncorrelated, so that said composition of noise sources synthesizes said noise components in a relation-preserved way.

The relation between said audio signals is determined by measuring the auto-correlation coefficients and cross-correlation coefficients of the audio channels 2. This correlation information may be represented in a correlation matrix expressing the auto-correlation coefficients and intercorrelation coefficients. In this matrix, the coefficient <S(i)S(i)> expresses the auto-correlation of a channel S(i); the coefficient <S(i)S(j)> expresses the intercorrelation between channel S(i) and channel S(j); i and j being some integral numbers denoting a specific one channel of said multi-channel system.

A set of transformation parameters 9 is calculated from this correlation matrix. The transformation parameters 9 are fed to a transmitter 10. The transformation parameters 9 relate to relevant parameters for synthesizing the noise sources. These transformation parameters may comprise an auto-correlation of the sources, corresponding to the energy of each uncorrelated noise signal, and an intercorrelation, describing a specific relation between said noise sources. These parameters 9 are to be received by a decoder for performing the inverse transformation on a set of generated noise sources, further explained with reference to FIG. 2.

The transformation parameters 9 are then combined with the sinusoidal encoded non-noisy signals 7, and transmitted as an encoded signal 11 by transmitter 10. The transmission may be a wireless transmission, or a transmission via the Internet, in fact, any kind of transmission. The transmission may also be done via a physical data carrier, such as a magnetic disk or a CD-rom etc.

In FIG. 2, essentially, the reverse of the scheme of FIG. 1 is illustrated, in a decoder 12 for decoding a signal 11 into a set of audio signals 21. The signal 11 comprises a set of transformation parameters for forming a plurality of noise sources according to the method of the invention.

In a first splitting stage 13, the transformation parameters 9 and the encoded non-noisy signals 7 are extracted from the signal 11. The non-noisy signals 7 are fed to a sinusoidal decoder 14, outputting non-noisy parts 51 of audio channels 21.

The transformation parameters 9 are fed to a noise source generating stage 15 comprising a set of independent (random) noise generators 16. The transformation parameters 9 indicate a noise level of each noise generator 16 (including a possible zero level); additionally, other parameters like, for instance, an enveloping form may be specified for the noise sources. The noise generator 16 generates a set of mutually uncorrelated noise sources that are formed, in response to the set of transformation parameters 9, for each audio signal 1 into a plurality of noise sources, thereby synthesizing perceptually relevant correlation-preserved noise components 41 for audio signals 21. In a composition stage 17, the correlation-preserved noise components 41 and the non-noisy parts 51 are combined and audio channels 21 are outputted, which are a perceptually relevant reconstruction of the audio channels 2 of FIG. 1

It will be clear to those skilled in the art that the invention is not limited to the embodiments described with reference to the drawing but may comprise all kinds of variations. For instance, although in the embodiments described, non-noisy parts of the signal are encoded using a sinusoidal coding, other types of encoding may be applied, like waveform coding or Huffman coding. Also, the audio channels as a whole, including non-noisy parts, may be transformed according to the above-mentioned transformation parameters. Furthermore, other types of noise encoding may be applied, using different parameters, etc. The method may be applied for a single relevant frequency band for an audio channel of a multi-channel audio system. The method may also be applied in a selected number of channels of a multi-channel audio system. These and other variations are deemed to fall within the scope of protection of the appended claims.

### Reference Numbers

1. encoder
2. composite arrows
3. filter stage
4. noisy parts
5. non-noisy parts
6. sinusoidal coding circuit
7. encoded data
8. noise encoding circuit
9. transformation parameters
10. transmitter
11. encoded signal
12. decoder
13. splitting stage
14. sinusoidal decoder
15. noise source generating stage
16. noise generators
17. composition stage

1. A method using synthetic noise sources in a multi-channel audio coding system for encoding a set of audio signals wherein correlated noise components are present, the method comprising the step of:
determining, from the relation between said audio signals, a composition of noise sources, the composition being such that the noise sources in said composition are mutually uncorrelated, so that said composition of noise sources synthesizes said noise components in a relation-preserved way.

2. A method according to claim 1, further comprising the step of:
encoding the noise sources, by determining for each noise source a set of noise parameters for synthesizing said source and a set of transformation parameters for generating said composition of noise sources.

3. A method according to claim 1 further comprising the steps of:
transmitting said sets of noise parameters for synthesizing each noise source and transmitting said set of transformation parameters for forming said plurality of noise sources.

4. A method according to claim 1, wherein mutually uncorrelated noise sources are determined on a frame-by-frame basis.

5. A method according to claim 1, wherein non-noisy components present in said audio signals are encoded by sinusoidal coding.

6. A method according to claim 1, wherein said transformation parameters are determined by orthogonalizing the correlation matrix of said set of audio channels.

7. A method according to claim 1, wherein the set of audio signals is divided into a selected set of frequency bands, at least one of the frequency bands comprising noise-like signals.

8. A method using synthetic noise sources in a multi-channel audio coding system for encoding a set of audio channels, the method comprising the steps of:
receiving sets of noise parameters for synthesizing noise sources and receiving a set of transformation parameters determined according to the method of claim 1;
generating, in response to said noise parameters, a set of synthesized noise sources; and
generating a set of audio signals by forming each audio signal as a plurality of noise sources according to said transformation parameters.

9. An encoder, for encoding audio channels encoded according to claim 1, the encoder comprising:
means for detecting, in at least one frequency band of said audio signals, an auto-correlation and a cross-correlation between each one of a set of audio signals; and
processing means for determining, from the relation between said audio signals, a composition of noise sources, the composition being such that the noise sources in said composition are mutually uncorrelated, so that said composition of noise sources synthesizes said noise components in a relation-preserved way.

10. An encoder of claim 8, further comprising:
means for encoding said noise sources as sets of noise parameters for synthesizing each of said sources,
transmitting means for transmitting the sets of noise parameters and for transmitting said set of transformation parameters for forming said plurality of noise sources.

11. A decoder for receiving audio channels encoded and transformed according to claim 1, the decoder comprising:
receiving means for receiving sets of noise parameters for synthesizing noise sources and for receiving a set of transformation parameters for forming a plurality of said noise sources,
a set of noise generators for generating noise sources, in response to the noise parameters; and
synthesizing means for synthesizing audio signals with perceptually relevant correlation-preserved noise components by forming, in response to the set of transformation parameters, for each audio signal a plurality of said set of noise sources.

12. A data carrier comprising a set of noise parameters for synthesizing uncorrelated noise sources and comprising a set of transformation parameters for forming a plurality of noise sources according to claim 1.
